(19) United States
(12) Patent Application Publication
(10) Pub. No.: US 2013/0294632 A1
(43) Pub. Date: Nov. 7, 2013

(54) Panel-form loudspeaker

(71) Applicants: Chao Wang, Shenzhen (CN); Bin Xu, Shenzhen (CN)

(72) Inventors: Chao Wang, Shenzhen (CN); Bin Xu, Shenzhen (CN)

(21) Appl. No.: 13/751,507

(22) Filed: Jan. 28, 2013

(30) Foreign Application Priority Data
May 4, 2012 (CN) 201220196089.X

(51) Int. Cl. H04R 1/28

(52) U.S. Cl. CPC H04R 1/2811
USPC 381/345

(57) ABSTRACT

Disclosed is a panel-form loudspeaker. The panel-form loudspeaker includes a resonant mode sound radiating panel, a case with a vibrating plate attached on the sound radiating panel, and a number of transducers separated from each other for forming a vibration and connected with the vibrating plate for transferring the vibration to the vibrating plate to cause the sound radiating panel to resonate and radiate an acoustic output. The vibrating plate has a number of vibrating portions mounting on the sound radiating panel and spaced from each other for fixing the transducers and a number of bending portions extending from the vibrating portions away from the sound radiating panel.

### FIELD OF THE INVENTION

The present invention generally relates to a loudspeaker, and more particularly, to an panel-form loudspeaker.

### DESCRIPTION OF RELATED ART

A typical panel-form loudspeaker comprises a resonant mode sound radiating panel, a case attached on the sound radiating panel, a transducer received in the case and projecting from the case for directly connecting with the sound radiating panel. However, the transducer directly connects with the sound radiating panel, thereby reducing a lifetime of the transducer.

Another typical panel-form loudspeaker comprises a resonant mode sound radiating panel, a case attached on the sound radiating panel, and a transducer received in the case for generating a vibration. The case has a vibrating plate sandwiched between the transducer and the sound radiating panel for transferring a vibration generated from the transducer to cause the sound radiating panel to resonate and radiate an acoustic output. The vibrating plate has a platy shape and has an upper surface for mounting the transducer and a lower surface opposite to the upper surface and entirely attached on the sound radiating panel.

However, the entire lower surface of the vibrating plate is attached on the sound radiating panel to cause the sound radiating panel to resonate, thereby dispersing the amount vibration applied on the vibrating plate. The performance of the panel-form loudspeaker is undesirable.

### BRIEF DESCRIPTION OF THE DRAWINGS

FIG. 1 is an illustrative cross-sectional view of a panel-form loudspeaker in accordance with a first exemplary embodiment of the present disclosure.

FIG. 2 is an illustrative cross-sectional view of a panel-form loudspeaker in accordance with a second exemplary embodiment of the present disclosure.

### DETAILED DESCRIPTION OF THE EXEMPLARY EMBODIMENTS

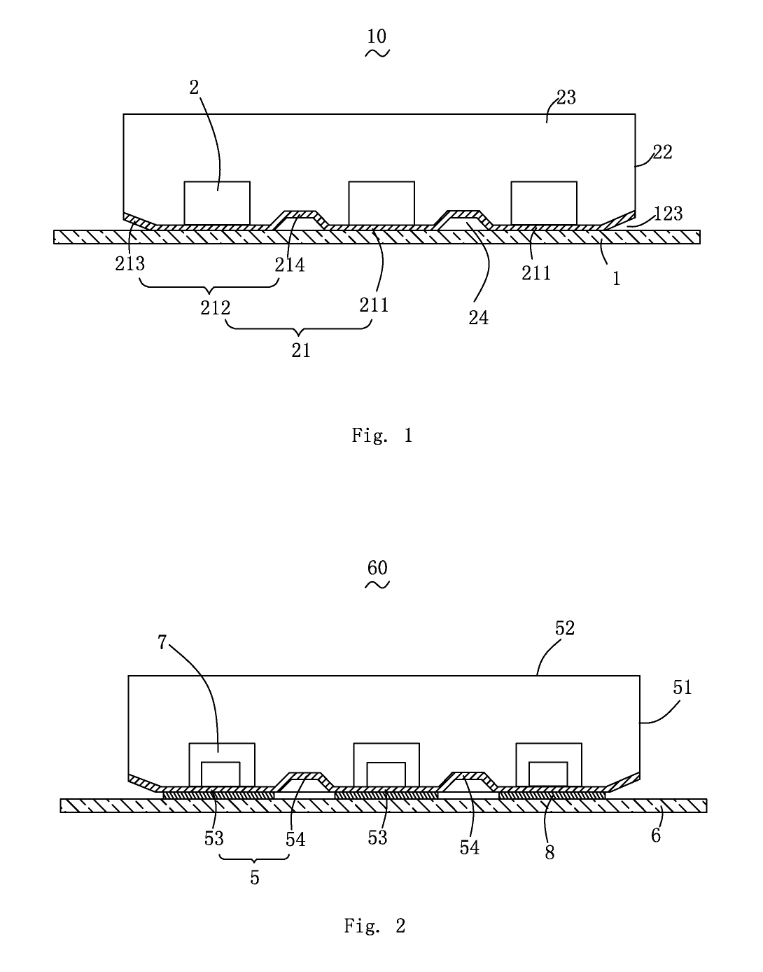

Referring to FIG. 1, a panel-form loudspeaker 10 in accordance with a first exemplary embodiment of the present disclosure comprises a resonant mode sound radiating panel 1, a case attached on the sound radiating panel 1, and a plurality of transducers 2 received in the case for forming a vibration.

The case has a vibrating plate 21 attached on the sound radiating panel 1, a cover 22 covered on the vibrating plate 1, and a receiving space 23 formed by the vibrating plate 21 together with the cover 22.

The transducers 2 are received in the receiving space 23 and attached on the vibrating plate 21 for transferring the vibration to the vibrating plate 21 to cause the sound radiating panel 1 to resonate and radiate an acoustic output. In this embodiment, the panel-form loudspeaker 10 has three transducers 2. Each transducer 3 is attached on the vibrating plate 21 and spaced from each other at a predetermined distance.

The vibrating plate 21 has a plurality of vibrating portions 211 mounting on the sound radiating panel 1 and spaced from each other at a predetermined distance for fixing the corresponding transducers 2, and a plurality of bending portions 212 extending from the vibrating portions 211 along a direction away from the sound radiating panel 1. The bending portions 212 have a first bending portion 213 for connecting two adjacent vibrating portions 211 and a second bending portion 214 disposed at two ends of the vibrating portion 211. The first bending portion 213 forms a space 24 together with the sound radiating panel 1. An upper surface of the bending portion 212 is higher than the upper surface of the vibrating portion 211. The amount of the transducers 2 is equal to that of the vibrating portions 211.

The vibration is mainly applied on the vibrating portion of the vibrating plate, thereby causing the sound radiating panel to resonate and radiate the acoustic output effectively and rapidly. The acoustic output of the sound radiating panel can be enhanced and the performance of the panel-form loudspeaker is desirable. Moreover, the bending portions further serves to dissipate the heat generated from the panel-form loudspeaker.

Although three transducers and three vibrating portions are respectively provided in the first embodiment, the number of transducers and vibrating portions is variable according to actual requirements.

A second embodiment of the present disclosure is shown in FIG. 2. A panel-form loudspeaker 60 comprises a resonant mode sound radiating panel 6, a case attached on the sound radiating panel 6, a plurality of transducers 7 received in the case for forming vibration, and a protecting portion 8 sandwiched between the case and the sound radiating panel 6.

The case has a vibrating plate 5 attached on the sound radiating panel 6, a cover 51 covered on the vibrating plate 5, and a receiving space 52 formed by the vibrating plate 5 together with the cover 51. The transducers 7 are received in the receiving space 52 and attached on the vibrating plate 5 for transferring the vibration to the vibrating plate 5 to cause the sound radiating panel 6 to resonate and radiate an acoustic output.

The vibrating plate 5 has a plurality of vibrating portion 53 mounting on the sound radiating panel 6 and spaced from each other at a predetermined distance for carrying the corresponding transducers 7, and a plurality of bending portions 54 extending from the vibrating portions 53 away from the sound radiating panel 6. The protecting portion 8 is sandwiched between the vibrating plate 5 and the sound radiating plane 6 for preventing the distortion or deformation of the vibrating plate and the sound radiating panel, further for reducing noises generated when the sound radiating panel vibrates together with the vibrating plate.

While the present invention has been described with reference to the specific embodiments, the description of the invention is illustrative and is not to be construed as limiting the invention. Various of modifications to the present invention can be made to the exemplary embodiments by those skilled in the art without departing from the true spirit and scope of the invention as defined by the appended claims.

What is claimed is:

1. An panel-form loudspeaker comprising:
a resonant mode sound radiating panel;
a case attached on the sound radiating panel, the case having a vibrating plate attached on the sound radiating panel; and
a plurality of transducers spaced from each other, each transducer received in the case for generating vibration and connected with the vibrating plate for transferring the vibration to the vibrating plate for causing the sound radiating panel to resonate and radiate an acoustic output;
wherein, the vibrating plate has a plurality of vibrating portions mounting on the sound radiating panel and spaced from each other for fixing the transducers, and a plurality of bending portions extending from the vibrating portions away from the sound radiating panel.

2. The panel-form loudspeaker as described in claim 1, wherein the bending portion has a first bending portion for connecting two adjacent vibrating portions.

3. The panel-form loudspeaker as described in claim 1, wherein the bending portion further has a second bending portion disposed at least one end of the vibrating portion.

4. The panel-form loudspeaker as described in claim 1 further having a protecting portion sandwiched between the vibrating plate and the sound radiating plane for preventing the deformation of the vibrating plate and the sound radiating panel, further for reducing noises produced when the sound radiating panel vibrates together with the vibrating plate.

5. A panel-form loudspeaker, comprising:
a sound radiating panel;
a case carried by the sound radiating panel, the case including a vibrating plate attached on the sound radiating panel, and a cover forming a space together with the vibrating plate;
a plurality of vibrators received in the space of the case; wherein
the vibrating plate includes a plurality of protrusions protruding toward the cover, and a plurality of recesses spaced by the protrusions, each of the recesses has a bottom positioned on the sound radiating panel and carrying a corresponding vibrator thereon.

6. The panel-form loudspeaker as described in claim 5, wherein each of the protrusions forms a gap together with the sound radiating panel.

7. The panel-form loudspeaker as described in claim 5, wherein at least one of the ends of the vibrating panel forms an acute angel relative with the sound radiating panel.
